(19) United States
(12) Patent Application Publication
(10) Pub. No.: US 2002/0156863 A1
(43) Pub. Date: Oct. 24, 2002

(54) Apparatus and methods for managing caches on a gateway

(76) Inventor: Luosheng Peng, San Jose, CA (US)

Correspondence Address: Mr. Steven Artim, CEO, DoOnGo Technologies, Inc., 2065 Martin Avenue, Suite 108, Santa Clara, CA, 95050, US

(21) Appl. No.: 09/840,739

(22) Filed: Apr. 23, 2001

(51) Int. Cl. G06F 15/16

(52) U.S. Cl. 709/217

(57) ABSTRACT

An exemplary method for managing caches on a gateway comprises the steps of periodically checking a set of records in a database, each of the set of records corresponding to a set of files, selecting a record based on the checking, contacting a server to update or check status of a set of files corresponding to the record, and updating the set of files and the record in accordance with a response from the server.

### FIELD OF THE INVENTION

This invention relates to apparatus and methods for managing caches. In particular, this invention relates to apparatus and methods for managing caches on a gateway.

### BACKGROUND OF THE INVENTION

Generally, wireless/mobile devices are connected to servers on the Internet through one or more gateways. Using a micro-browser application on a mobile device, a user may browse the Internet through the gateway(s).

Most wireless/mobile devices have inadequate processing capability for retrieving information, such as applications or data, and very limited memory space for caching such information. Thus, downloading applications or data from the Internet onto a mobile device may be very slow and sometimes unsuccessful. One possible solution to circumvent the need to repeatedly download the same applications and data from servers connected to the Internet is to cache them on the gateway(s). Gateways also have limited memory space and cannot cache all available applications and data; thus, an intelligent caching of the most likely to be called applications or data is necessary to optimize this solution. Further, efficient management of the gateway cache space is necessary to ensure that applications and data stored in the cache are up-to-date and useful to users.

Thus, it is desirable to provide apparatus and methods for managing caches at the gateway.

### SUMMARY OF THE INVENTION

An exemplary method for managing caches on a gateway comprises the steps of periodically checking a set of records in a database, each of the set of records corresponding to a set of files, selecting a record based on the checking, contacting a server to update or check status of a set of files corresponding to the record, and updating the set of files and the record in accordance with a response from the server. In a preferred embodiment, each of the set of records is checked sequentially such that only one application/data at a time is inaccessible (during checking and updating). In another embodiment, the set of records could be checked or updated out of sequence.

In one embodiment, the periodically checking includes the steps of checking a first field of each record in the database to determine if a set of files corresponding to the record is up-to-date, checking a second field of each record in the database to determine if a next version release schedule corresponding to the record has expired, and checking a third field of each record to determine if an estimated update interval corresponding to the record has occurred. In another embodiment, the selecting step includes the steps of selecting a record having a corresponding sets of files that needs a status check or an update.

In an exemplary embodiment, the step of contacting a server includes the steps of authenticating the set of files, establishing a communication session with the server, sending an update request or a status check request to the server, and receiving an update response or a status check response from the server. In one embodiment, the update response includes at least one difference file and the status check response includes a current version and status of the set of files. In an exemplary embodiment, the set of files is updated by applying the at least one difference file to the set of files and updating at least one table in the database. In another exemplary embodiment, the set of files is updated by updating at least one table in the database based on the current version and status of the set of files. In yet another exemplary embodiment, the update response or the status check response is parsed for a broadcast message. If a broadcast message is found, at least one table in the database is accessed and updated based on the broadcast message and a broadcast response is sent to the server.

In another exemplary embodiment, the step of contacting a server step includes the steps of authenticating the set of files, establishing a connection with the server, downloading a current set of files from the server, comparing the current set of files to the set of files, and generating at least one difference file or a current version and status based on the comparing. In one embodiment, the set of files is updated by applying the at least one difference file to the set of files and updating at least one table in the database based. In another embodiment, the set of files is updated by replacing the set of files by the current set of files, storing the at least one difference file, and updating at least one table in the database. In yet another embodiment, the set of files is updated by updating at least one table in the database based on the current version and status.

An exemplary computer program product for use in conjunction with a computer system for managing caches on a gateway comprises logic code for periodically checking a set of records in a database, each of the set of records corresponding to a set of files, logic code for selecting a record based on the checking, logic code for contacting a server to update or check status of a set of files corresponding to the record, and logic code for updating the set of files and the record in accordance with a response from the server.

In an exemplary embodiment, the logic code for periodically checking includes logic code for checking a first field of each record in the database to determine if a set of files corresponding to the record is up-to-date, logic code for checking a second field of each record in the database to determine if a next version release schedule corresponding to the record has expired, and logic code for checking a third field of each record to determine if an estimated update interval corresponding to the record has occurred. In a preferred embodiment, the logic code for periodically checking includes logic code for sequentially checking each of the set of records. In one embodiment, the logic code for selecting a record includes logic code for selecting a record having a corresponding sets of files that needs a status check or an update.

In an exemplary embodiment, the logic code for contacting a server includes logic code for authenticating the set of files, logic code for establishing a communication session with the server, logic code for sending an update request or a status check request to the server, and logic code for receiving an update response or a status check response from the server, the update response including at least one difference file and the status check response including a current version and status of the set of files. In one embodiment, the logic code for updating the set of files includes logic code for applying the at least one difference file to the set of files and logic code for updating at least one table in the database. In another embodiment, the logic code for updating the set of files includes logic code for updating at least one table in the database based on the current version and status of the set of files.

In another exemplary embodiment, the logic code for contacting a server includes logic code for authenticating the set of files, logic code for establishing a connection with the server, logic code for downloading a current set of files from the server, logic code comparing the current set of files to the set of files, and logic code for generating at least one difference file or a current version and status based on the comparing. In one embodiment, the logic code for updating the set of files includes logic code for applying the at least one difference file to the set of files and logic code for updating at least one table in the database based. In another embodiment, the logic code for updating the set of files includes logic code for replacing the set of files by the current set of files, logic code for storing the at least one difference file, and logic code for updating at least one table in the database. In yet another embodiment, the logic code for updating the set of files includes logic code for updating at least one table in the database based on the current version and status.

In yet another exemplary embodiment, the computer program product also includes logic code for parsing the update response or the status check response for a broadcast message, logic code for accessing and updating at least one table in the database based on the broadcast message, and logic code for sending a broadcast response to the server.

### BRIEF DESCRIPTION OF THE DRAWINGS

FIG. 1 schematically illustrates an exemplary system in accordance with an embodiment of the invention.

FIG. 2 schematically illustrates an exemplary gateway in accordance with an embodiment of the invention.

FIG. 3 schematically illustrates an exemplary two level transaction support process in accordance with an embodiment of the invention.

FIG. 4 illustrates an exemplary application identification table in accordance with an embodiment of the invention.

FIG. 5 illustrates an exemplary data identification table in accordance with an embodiment of the invention.

FIG. 6 illustrates an exemplary application registration table in accordance with an embodiment of the invention.

FIG. 7 illustrates an exemplary compression methods table in accordance with an embodiment of the invention.

FIG. 8 illustrates an exemplary compatible (3i) server registration table in accordance with an embodiment of the invention.

FIG. 9 illustrates an exemplary session management table in accordance with an embodiment of the invention.

FIG. 10 illustrates an exemplary application download/update histories table in accordance with an embodiment of the invention.

FIG. 11 illustrates an exemplary data download/update histories table in accordance with an embodiment of the invention.

FIG. 12 illustrates an exemplary application storage table in accordance with an embodiment of the invention.

FIG. 13 illustrates an exemplary data storage table in accordance with an embodiment of the invention.

FIG. 14 illustrates an exemplary broadcast table in accordance with an embodiment of the invention.

FIG. 15 illustrates an exemplary configuration table in accordance with an embodiment of the invention.

FIG. 16 illustrates an exemplary process in accordance with an embodiment of the invention.

FIG. 17 illustrates another exemplary process in accordance with an embodiment of the invention.

FIG. 18 illustrates another exemplary process in accordance with an embodiment of the invention.

FIG. 19 illustrates another exemplary process in accordance with an embodiment of the invention.

FIG. 20 illustrates an exemplary process for identifying differences between two application/data versions in accordance with an embodiment of the invention.

FIG. 21 schematically illustrates exemplary smart connectivity protocol state machines in accordance with an embodiment of the invention

### DETAILED DESCRIPTION OF THE INVENTION

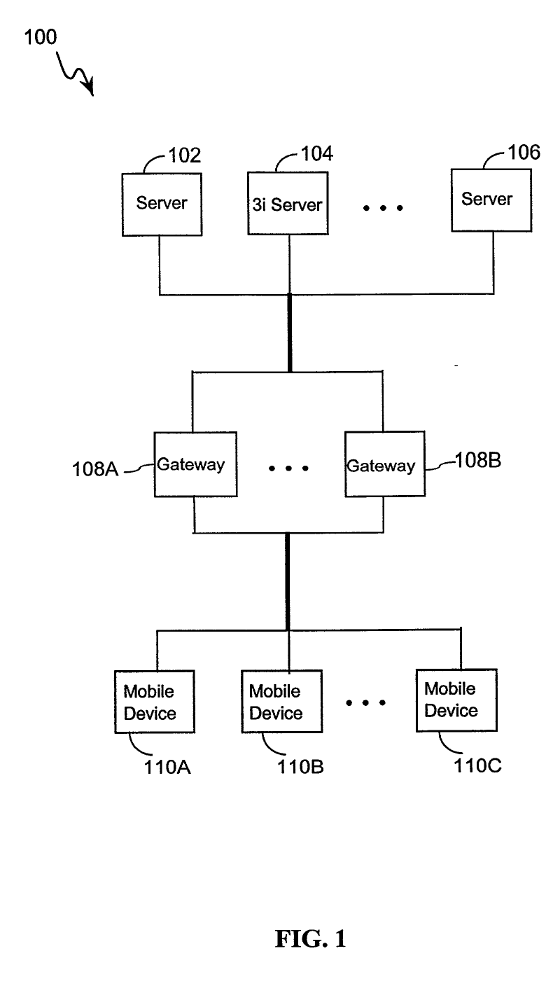

FIG. 1 illustrates an exemplary system 100. The system 100 includes multiple servers connected to multiple gateways that service multiple mobile devices. For ease of explanation, only a representative number of servers, gateways, and mobile devices are shown in FIG. 1. The system 100 includes servers 102-106, gateways 108A-108B, and mobile devices 110A-110C. In an exemplary embodiment, the server 104 is a compatible server (3i server) that is capable of differentially updating applications and data stored at the gateway 108 or the mobile device 110.

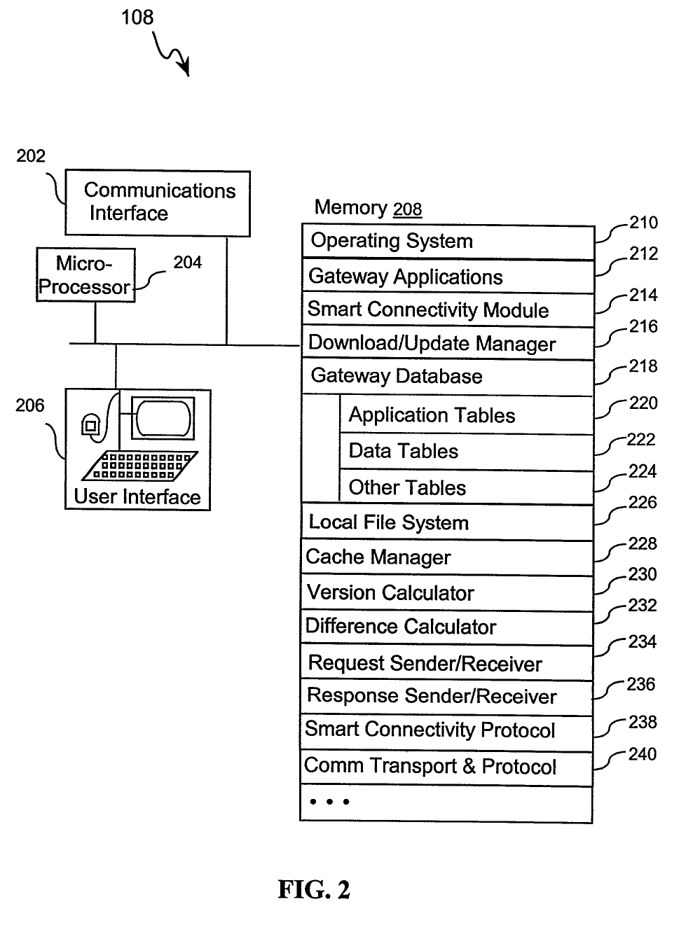

FIG. 2 schematically illustrates an exemplary gateway 108 in accordance with an embodiment of the invention. The gateway 108 includes a communications interface 202 for communicating with a network, a microprocessor 204, a user interface 206, and a memory 208. In an exemplary embodiment, the user interface includes a user input device (e.g., keyboard) and an output device (e.g., screen). The memory 208 includes an operating system 210, gateway applications 212, a smart connectivity module 214, a download/update manager 216, a gateway database 218, a local file system 226, a cache manager 228, a version calculator 230, a difference calculator 232, a request sender/receiver 234, a response sender/receiver 236, a smart connectivity protocol 238, and a communications transport protocol module 240 for adapting to different transport protocols in the network. In an exemplary embodiment, the gateway database 218 includes a set of application tables 220, a set of data tables 222, and a set of other tables 224 for storing download/update histories, cache storage, broadcast, configuration, and other information.

In an exemplary embodiment, the gateway applications 212 provide standard gateway functions. The request sender/receiver 234 receives requests sent by subscribing mobile devices 110 and passes the requests to the smart connectivity module 214. The smart connectivity module 214 determines whether an application or data requested for execution or access is already stored in the local file system 226 and whether a cached application or data is up-to-date. The smart connectivity module 214 sends a request to a remote server 102-106 via the download/update manager 216 to download or update the requested application or data if it is not stored in the local file system 226 or if it is out-of-date. The smart connectivity module 214 intelligently determines (based on a calculated cache benefit index) whether a downloaded application/data should be cached, and if so, whether there is enough space to do so. Additionally, the smart connectivity module 214 maintains meta information (i.e., synchronization version and application/data identification information, etc.) for all cached applications/data in the gateway database 218 in one or more of the tables 220-224.

The smart connectivity module 214 generates a response to the request from the mobile device 110 and calls the response sender/receiver 236 to send the response to the mobile device 110. Detailed description regarding the cache benefit index (CBI) and methods to intelligently cache applications and data on a gateway is provided in a co-pending application entitled “Apparatus and Methods for Intelligently Caching Application and Data on a Gateway,” bearing application Ser. No. ______, filed on ______. This co-pending application is hereby incorporated for all purposes.

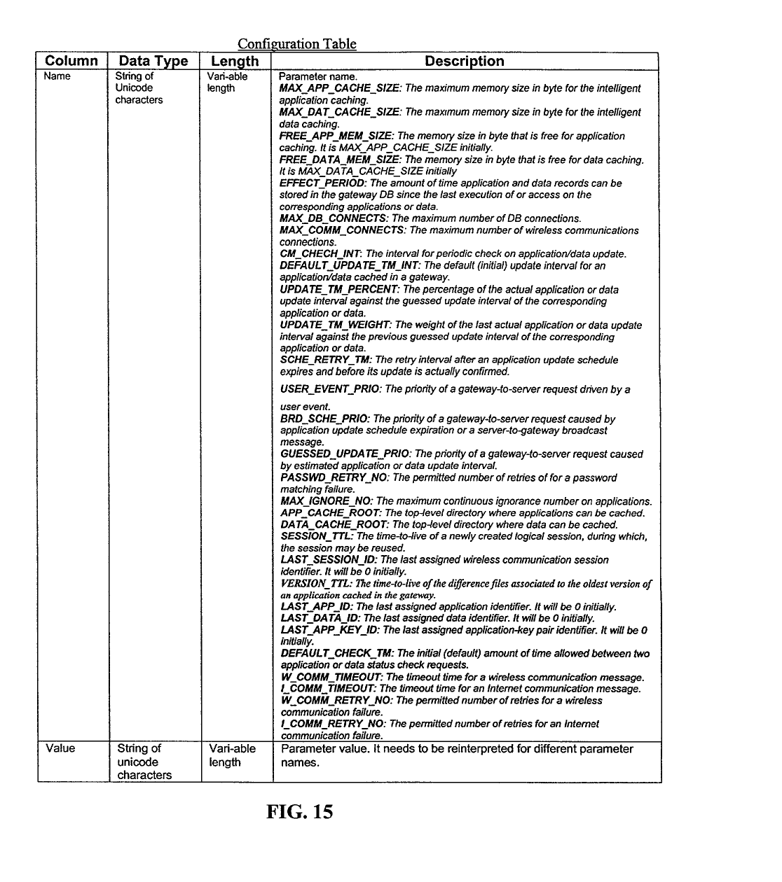

The cache manager 228 periodically initiates a check on all applications/data cached in the gateway 108 and sends requests to servers 102-106 when it determines that some applications/data need to be updated or checked. The intervals for the periodic checks are specified in a configuration table (see FIG. 15 below) in the gateway database 218. In an exemplary embodiment, the intervals are determined in accordance with achieving a balance between minimizing performance downgrade and maintaining the integrity of the applications/data cached at the gateway 108.

During a periodic check, the cache manager 228 accesses the gateway database 218 to identify all applications/data that need to be updated or checked. In a preferred embodiment, the applications/data cached at the gateway 108 are checked/updated in a sequential order, such that only one application or data is inaccessible (due to status check or update) at a time. In other embodiment, multiple applications/data may be checked/updated at the same time, depending on the design goal of the system. For each identified application, the cache manager 228 authenticates the application/data when necessary, initiates an update or status check process by sending an appropriate request to a server 102-106 via the request sender 234, and receives a response via the response receiver 236.

The determination of whether a cached application/data should be updated or checked is based on three parameters, namely, an update broadcast message (from a 3i server), a next version release schedule of the application/data (from a 3i server), or an estimated update interval based on past update history. Generally, cache manager 228 initiated requests (e.g., update or status check requests) have a lower priority than user initiated request (e.g., download, update or status check requests from the mobile device 110), which are processed by the smart connectivity module 214.

When the cache manager 228 initiates a download from a non-3i server 102 or 106 during update or status check processes, the downloaded application/data needs to be further processed at the gateway 108. For example, the cache manager 228 calls the version calculator 230 to generate version information regarding the downloaded application/data and compares the downloaded application/data to a corresponding cached application/data. If the versions between the downloaded and cached applications/data are different, the cache manager 228 calls the difference calculator 232 to generate one or more difference files. Difference files are used to update cached applications/data on the local file system 226 of the gateway differentially.

When an application/data is downloaded or cached, all files belonging to that application/data, including the executable files, configuration files, property files, online help files, etc., are processed as a bundle.

Communications between the gateway 108 and a 3i server 104 are based on the smart connectivity protocol 238 that is stacked on top of the communication transport and protocol 240 (e.g., wireless application protocol (WAP), TCP/IP, HTTP, infra-red data association (IrDA), or Bluetooth). Communications between the gateway 108 and other servers (non-3i servers) 102 or 106 are based only on the communication transport and protocol 240.

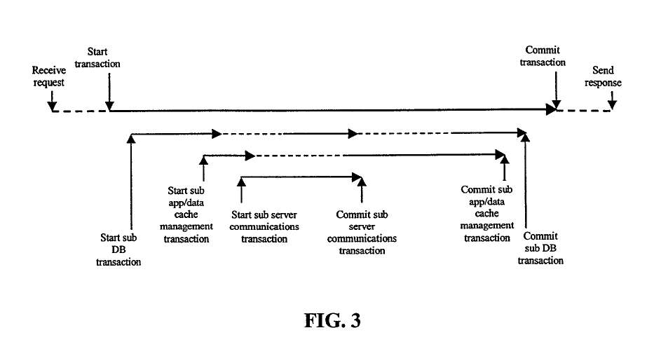

FIG. 3 illustrates an exemplary transaction and sub-transaction management in accordance with an embodiment of the invention. During each application/data downloading/updating/status checking, the cache manager 228 maintains the consistency and integrity among database operations and application/data cache space management. A transaction corresponding to an application/data update or status check is created after the cache manager 228 initiates the update or status check request on the gateway 108. The transaction is committed when the cache manager 228 succeeds in the update or status check processes; otherwise, if the cache manager 228 fails in the processes, the transaction is rolled back to its original state. In an exemplary embodiment, during a transaction processing, the cache manager 228 may also create several sub-transactions within the transaction for various database operations. For example, the sub-transactions include an application or data cache space management transaction and communication transactions with the servers 102-106. Sub-transactions become fully committed when the initial transaction becomes committed.

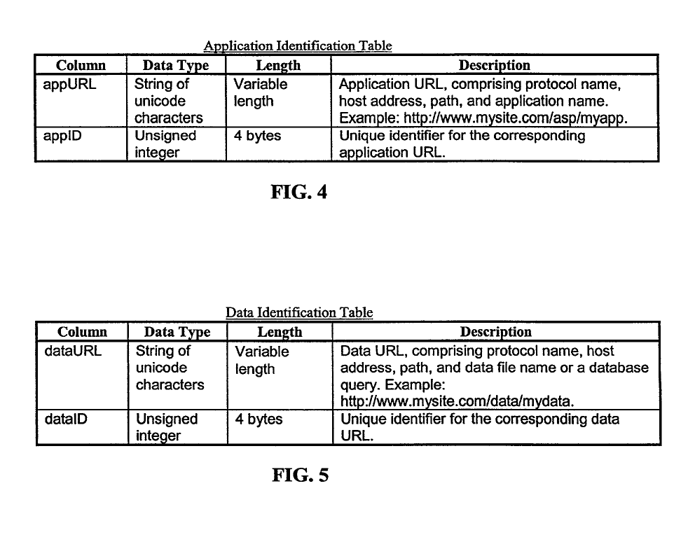

In an exemplary embodiment, the gateway database 218 includes a number of tables 220-224. Each table is designed to maintain a type of logical information. The cache manager 228 updates the gateway database 218 and the local file system 226 in accordance with each operation performed. In an exemplary embodiment, the gateway database 218 is managed in the gateway 108 by a third-party (commercially available) database management system running on one or more UNIX servers. In one embodiment, twelve tables are maintained in the gateway database 218. Exemplary tables are illustrated in FIGS. 4-15 below.

FIG. 4 illustrates an exemplary application identification table. The purpose of this table is to associate each application uniform resource locator (URL) to a unique identification.

FIG. 5 illustrates an exemplary data identification table. The purpose of this table is to associate each data URL to a unique identifier.

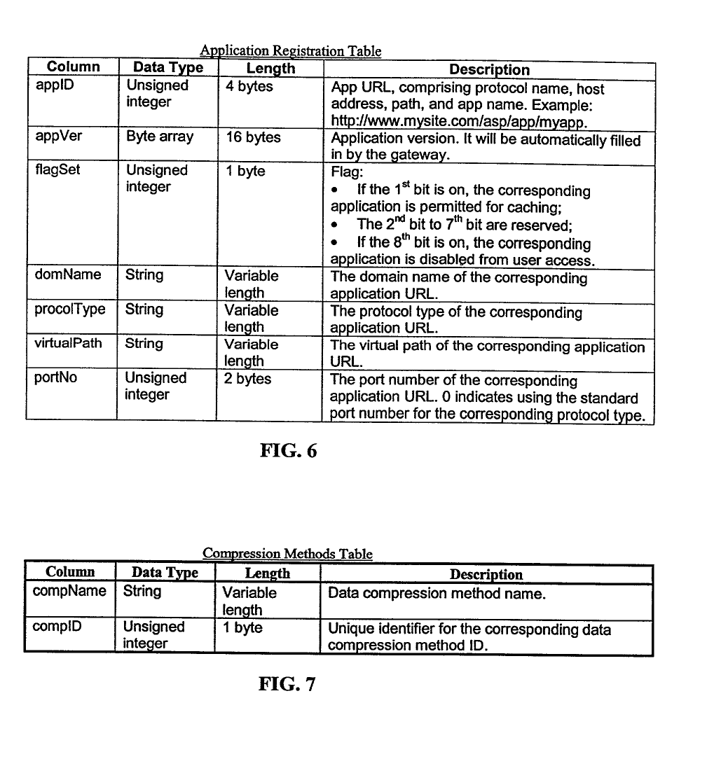

FIG. 6 illustrates an exemplary application registration table. The purpose of this table is to maintain application registration and access control on applications.

FIG. 7 illustrates an exemplary compression methods table. The purpose of this table is to associate each data compression method name to a unique identifier.

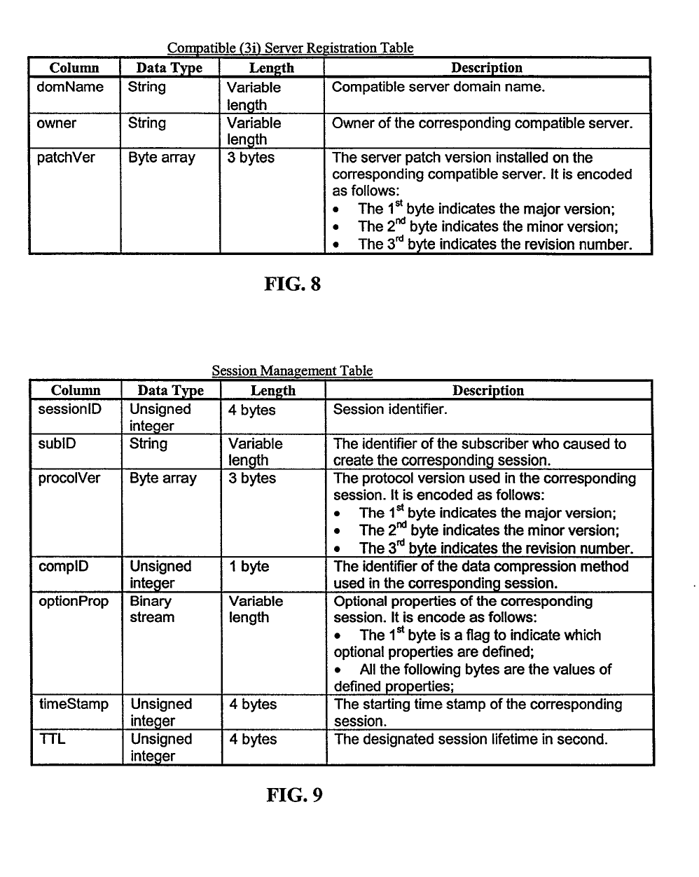

FIG. 8 illustrates an exemplary compatible (3i) server registration table. The purpose of this table is to maintain a list of all 3i servers in the system 100.

FIG. 9 illustrates an exemplary session management table. The purpose of this table is to maintain the properties of all live or reusable sessions.

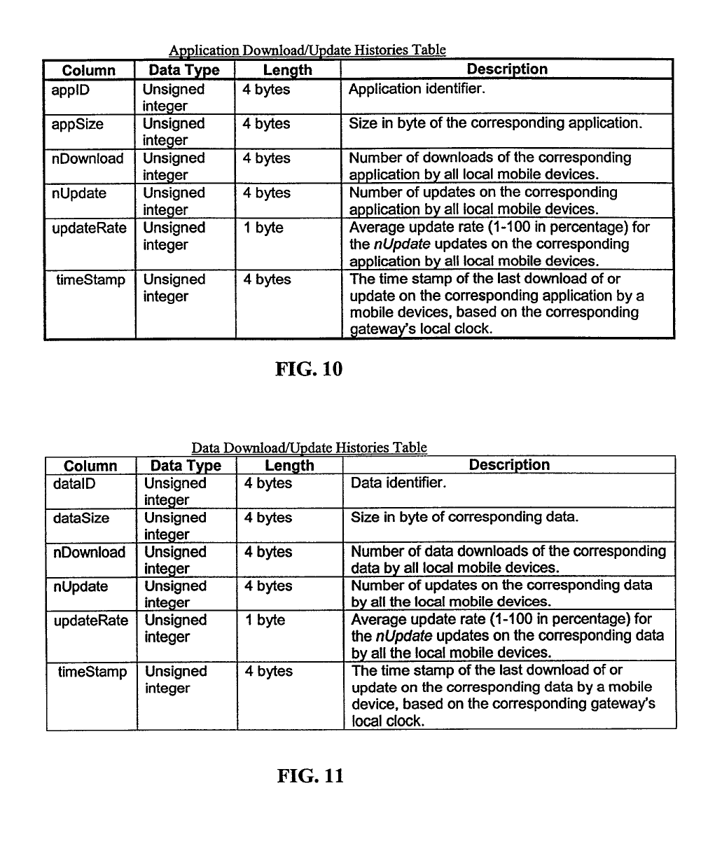

FIG. 10 illustrates an exemplary application download/update table. The purpose of this table is to track the download and update histories of all applications ever downloaded by each subscribing mobile device 110.

FIG. 11 illustrates an exemplary data download/update table. The purpose of this table is to track the download and update histories of all data ever downloaded by each subscribing mobile device 110.

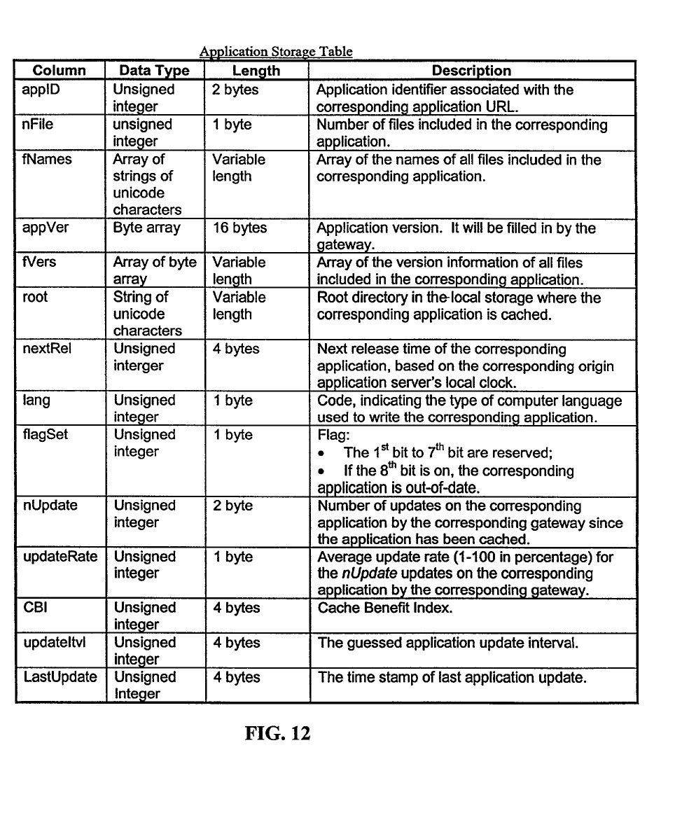

FIG. 12 illustrates an exemplary application storage table. The purpose of this table is to maintain the meta information associated with all cached applications in each gateway 108.

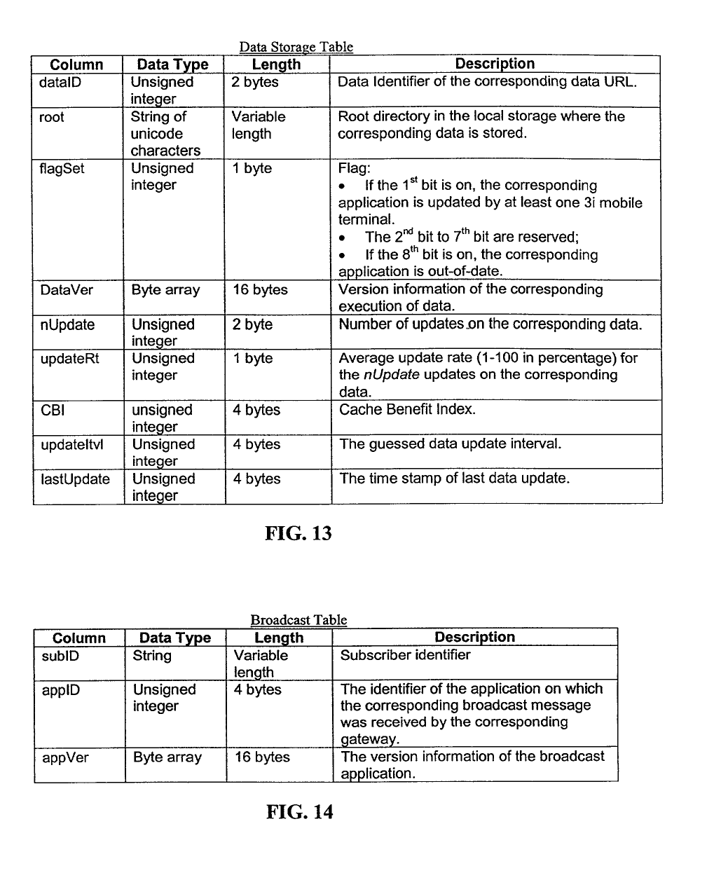

FIG. 13 illustrates an exemplary data storage table. The purpose of this table is to maintain the meta information associated with all cached data in each gateway 108.

FIG. 14 illustrates an exemplary broadcast table. The purpose of this table is to maintain application broadcast messages that should be piggybacked to mobile devices 110.

FIG. 15 illustrates an exemplary configuration table. The purpose of this table is to set and maintain a set of configuration parameters that control the behavior of the gateway 108.

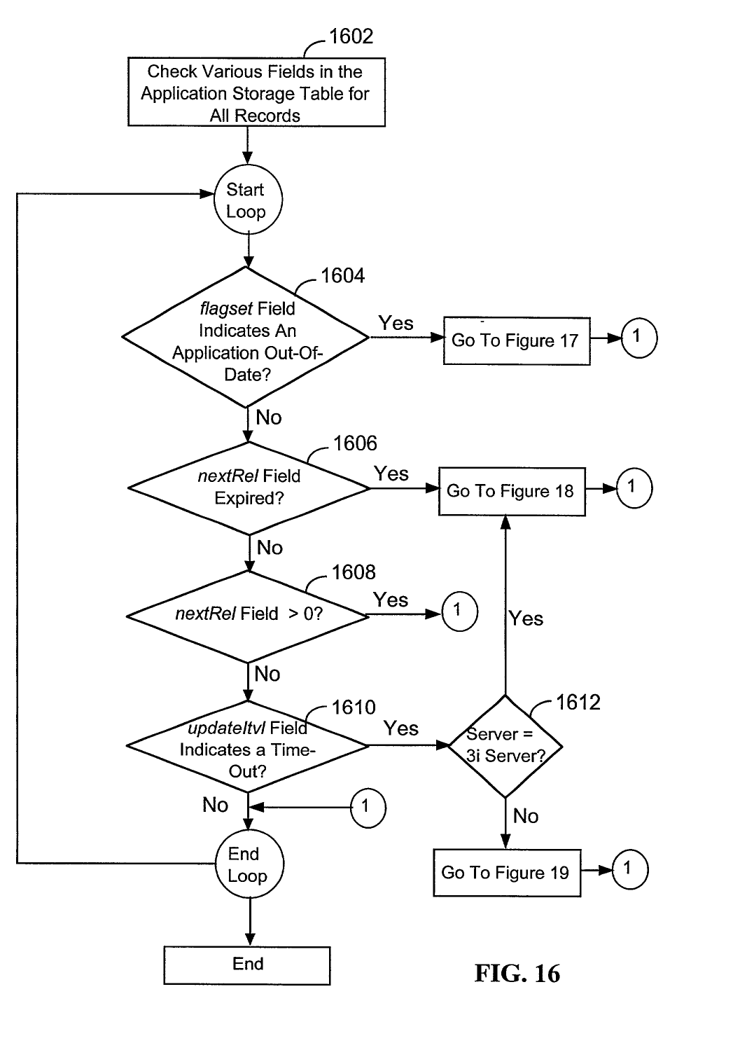

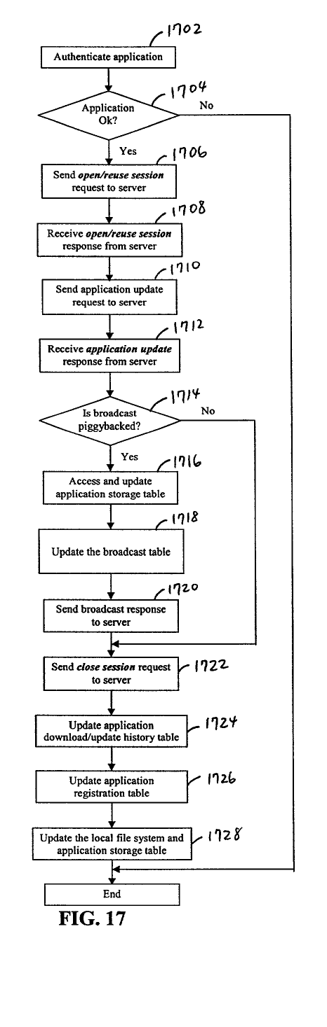

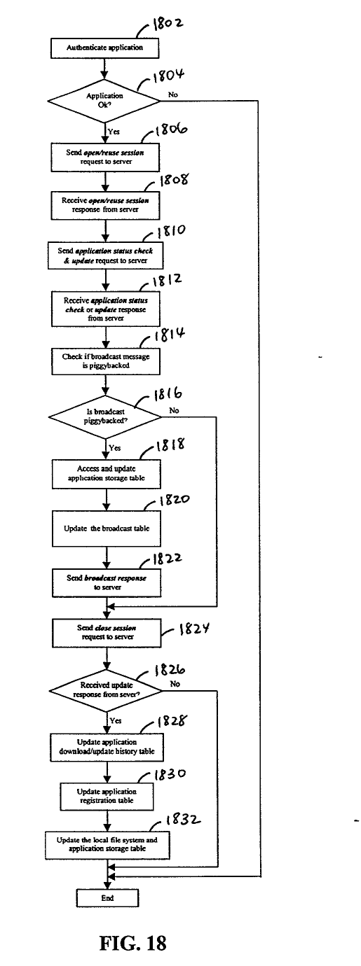

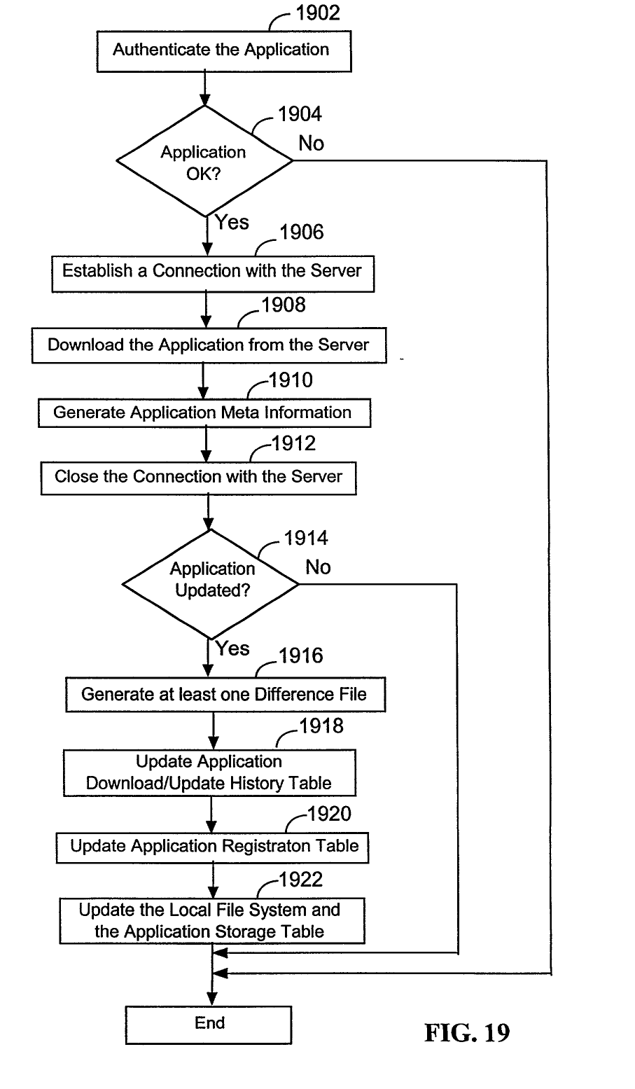

FIG. 16 illustrates an exemplary periodic check process performed by the cache manager 228 in accordance with an embodiment of the invention. At step 1602, the cache manager 228 initiates a periodic check by searching the application storage table (see FIG. 12) for the “appId,” “flagset,” “nextRel,” “updateItvl,” and “lastUpdate” fields of all records. For each record, whether the “flagset” field in the record indicates that the corresponding application/data is out-of-date is determined (step 1604). If so, the process continues at FIG. 17 for that application/data. Otherwise, whether the “nextRel” field of the record has expired is determined (step 1606). The “nextRel” field has expired when it indicates a point in time older than the current time. If so, the process continues at FIG. 18 for that application/data. Otherwise, whether the “nextRel” field of the record is greater than zero but has not expired is determined (step 1608). If so, the loop ends for this record and the next record is checked at step 1604. Otherwise, whether the “updateItvl” field, which indicates an estimated update interval, in the record indicates a timeout is determined (step 1610). In an exemplary embodiment, a timeout occurs when the current time minus the lastUpdate field value is greater than the product of the “UPDATE_TM_PERCENT” value and the “updateltvl” field value. If so, whether the original server of the application is a 3i server is determined by examining the 3i server registration table (see FIG. 8) (step 1612). If the original server is a 3i server, the process continues at FIG. 18; otherwise, the process continues at FIG. 19. If the “updateItvl” does not indicate a time out, the loop process for the first record ends and the next record is checked at step 1604 until all records in the application storage table have been checked. A similar process is performed by the cache manager 228 in the data storage table (see FIG. 13).

FIG. 17 illustrates an exemplary update process between the cache manager 228 and the 3i server 104 in accordance with an embodiment of the invention. In an exemplary embodiment, an update request is sent to the 3i server 104 when the cache manager determines that an application/data is out-of-date. For ease of explanation, FIG. 17 illustrates a process to update an application; the same process is similarly applied when updating data. At step 1702, the cache manager 228 authenticates the application to be updated. In an exemplary embodiment, the application registration table (see FIG. 6) in the gateway database 218 is searched for a record that matches the application's ID. If no matching record is found (step 1704), the application cannot be authenticated and the process ends. If a matching record is found (step 1704), the application is authenticated. Next, an open/reuse communication session request is sent to the server 104 via the request sender 234 (step 1706). An open/reuse session response is received from the server 104 via the response receiver 236 (step 1708). Once the communication session is established, an application update request is sent to the server 104 via the request sender 234 (step 1710). An application update response is received from the server 104 via the response receiver 236 (step 1712). In an exemplary embodiment, the update response includes at least one difference file. Next, whether a broadcast message is piggybacked in the response is checked (step 1714). If not, the process continues at step 1722. If a broadcast response is piggybacked, the application storage table (see FIG. 12) is accessed and updated (step 1716). In an exemplary embodiment, a broadcast message includes an application URL and an application version for each of one or more applications. The application storage table is searched for the appVer and flagSet fields of each record that is associated with an application URL component in the broadcast message. The appVer of a matching record and an application version component in the broadcast message are compared. If the versions are different, then set a corresponding fagSet field to indicate that the associated application is out-of-date. The process repeats for all applications in the broadcast message. Next, the broadcast table (see FIG. 14) is updated (step 1718). In an exemplary embodiment, a record comprising a subId, the application URL, and the application version is created and inserted into the broadcast table. Next, a broadcast response is sent back to the server 104 (step 1720).

At step 1722, a close session request is sent to the server 104 and the communication is disconnected. The application download/update histories table (see FIG. 10) is updated (step 1724). In an exemplary embodiment, a corresponding record in the application download/update histories table is updated as follows: the “appSize” field value is replaced with the application size of the updated application. Next, the application registration table (see FIG. 6) is updated (step 1726). In an exemplary embodiment, a corresponding record in the application registration table is updated as follows: the “appVer” field is replaced with the version of the updated application. Finally, the local file system 226 and the application storage table (see FIG. 12) are updated (step 1728). In an exemplary embodiment, the local file system 226 is updated by applying the at least one difference file to the cached application. The application storage table is updated by updating fields, including the “number of files,” “file names,” “file versions,” “next application release schedule,” “language,” “flagSet,” “nUpdate,” “updateRate,” “CBI,” “updateItvl,” and “lastUpdate” fields. In one embodiment, the new nUpdate is equal to the old nUpdate+1. The new updateRate is equal to (the old updateRate×old nUpdate+diffSize×100/appSize)/new nUpdate, where diffSize is the size difference between the new and old versions of the application. The new CBI is equal to the old CBI−diffSize. The new updateItvl is equal to (1−UPDATE_TM_WEIGHT)×old updateItvl+UPDATE_TM_WEIGHT×(timestamp_{now}−lastUpdate), where the timestamp_{now} is the current time. The new lastUpdate is equal to the timestamp_{now}.

FIG. 18 illustrates an exemplary status check or update process between the cache manager 228 and the 3i server 104 in accordance with an embodiment of the invention. In an exemplary embodiment, a status check or update request is sent to the 3i server 104 when a next version release schedule has expired or when an estimated update interval timeout occurs. For ease of explanation, FIG. 18 illustrates a process to status check or update an application; the same process is similarly applied when performing a status check or update on data. At step 1802, the cache manager 228 authenticates the application to be status checked or updated. In an exemplary embodiment, the application registration table (see FIG. 6) in the gateway database 218 is searched for a record that matches the application's ID. If no matching record is found (step 1804), the application cannot be authenticated and the process ends. If a matching record is found (step 1804), the application is authenticated. Next, an open/reuse communication session request is sent to the server 104 via the request sender 234 (step 1806). An open/reuse session response is received from the server 104 via the response receiver 236 (step 1808).

Once the communication session is established, an application status check or update request is sent to the server 104 via the request sender 234 (step 1810). An application status check or update response is received from the server 104 via the response receiver 236 (step 1812). In an exemplary embodiment, the response may be a status check response that includes the current version and status of the application at the server 104 or an update response that includes at least one difference file. Next, whether a broadcast message is piggybacked in the response is checked (step 1814). If not (step 1816), the process continues at step 1824. If a broadcast response is piggybacked (step 1816), the application storage table (see FIG. 12) is accessed and updated (step 1818). In an exemplary embodiment, a broadcast message includes an application URL and an application version for each of one or more applications. The application storage table is searched for the appVer and flagSet fields of each record that is associated with an application URL component in the broadcast message. The appVer of a matching record and an application version component in the broadcast message are compared. If the versions are different, then set a corresponding flagSet field to indicate that the associated application is out-of-date. The process repeats for all applications in the broadcast message. Next, the broadcast table (see FIG. 14) is updated (step 1820). In an exemplary embodiment, a record comprising a subId, the application URL, and the application version is created and inserted into the broadcast table. Next, a broadcast response is sent back to the server 104 (step 1822).

At step 1824, a close session request is sent to the server 104 and the communication is disconnected. Next, whether the response is an update response is determined (step 1826). If not, the process ends. If the response is an update response, the application download/update histories table (see FIG. 10) is updated (step 1828). In an exemplary embodiment, a corresponding record in the application download/update histories table is updated as follows: the “appSize” field value is replaced with the application size of the updated application. Next, the application registration table (see FIG. 6) is updated (step 1830). In an exemplary embodiment, a corresponding record in the application registration table is updated as follows: the “appVer” field is replaced with the version of the updated application. Finally, the local file system 226 and the application storage table (see FIG. 12) are updated (step 1832). In an exemplary embodiment, the local file system 226 is updated by applying the at least one difference file to the cached application. The application storage table is updated by updating fields, including the “number of files,” “file names,” “file versions,” “next application release schedule,” “language,” “flagSet,” “nUpdate,” “updateRate,” “CBI,” “updateItvl,” and “lastUpdate” fields. In one embodiment, the new nUpdate is equal to the old nUpdate+1. The new updateRate is equal to (the old updateRate×old nUpdate+diffSize×100/appSize)/new nUpdate, where diffSize is the size difference between the new and old versions of the application. The new CBI is equal to the old CBI−diffSize. The new updateItvl is equal to (1−UPDATE_TM_WEIGHT)×old updateItvl+UPDATE_TM_WEIGHT×(timestamp_{now}−lastUpdate), where the timestamp_{now} is the current time. The new lastUpdate is equal to the timestamp_{now}.

FIG. 19 illustrates an exemplary status check and update process between the cache manager 228 and a non-3i server 102 or 106 in accordance with an embodiment of the invention. In an exemplary embodiment, such a status check and update process takes place when an estimated update interval timeout occurs. For ease of explanation, FIG. 19 illustrates a process to status check or update an application; the same process is similarly applied when performing a status check or update on data. At step 1902, the cache manager 228 authenticates the application to be status checked or updated. In an exemplary embodiment, the application registration table (see FIG. 6) in the gateway database 218 is searched for a record that matches the application's ID. If no matching record is found (step 1904), the application cannot be authenticated and the process ends. If a matching record is found (step 1904), the application is authenticated. Next, a communication connection is established with the server 102 (step 1906). After a connection is established, the current version of the application is downloaded from the server 102 (step 1908). Corresponding application meta information is generated (step 1910). In an exemplary embodiment, values for the “application version,” “file versions,” “number of files,” and “application size” fields are generated. Next, the connection to the server 102 is closed (step 1912). The downloaded application is compared to a corresponding application cached at the gateway 108 (step 1914). If the application versions are identical, the process ends because the cached application is up-to-date. Otherwise, at least one difference file is generated (step 1916). The application download/update histories table (see FIG. 10) is updated (step 1918). In an exemplary embodiment, a corresponding record in the application download/update histories table is updated as follows: the “appSize” field value is replaced with the application size of the updated application. Next, the application registration table (see FIG. 6) is updated (step 1920). In an exemplary embodiment, a corresponding record in the application registration table is updated as follows: the “appVer” field is replaced with the version of the updated application. Finally, the local file system 226 and the application storage table (see FIG. 12) are updated (step 1922). In an exemplary embodiment, the local file system 226 is updated by replacing the cached application with the received application and properly saving the difference file. The application storage table is updated by updating fields, including the “number of files,” “file names,” “file versions,” “next application release schedule,” “language,” “flagSet,” “nUpdate,” “updateRate,” “CBI,” “updateItvl,” and “lastUpdate” fields. In one embodiment, the new nUpdate is equal to the old nUpdate+1. The new updateRate is equal to (the old updateRate×old nUpdate+diffSize×100/appSize)/new nUpdate, where diffSize is the size difference between the new and old versions of the application. The new CBI is equal to the old CBI−diffSize. The new updateItvl is equal to (1−UPDATE_TM_WEIGHT)×old updateItvl+UPDATE_TM_WEIGHT×(timestamp_{now}−lastUpdate), where the timestamp_{now} is the current time. The new lastUpdate is equal to the timestamp_{now.}

In an exemplary embodiment, application and file versions are calculated by applying a one-way hashing function (e.g., MD4). To calculate an application version, all files belonging to an application are organized in a defined order then a one-way hashing function is applied to the files. This method assumes that servers generally download contents of an application in a consistent order. To calculate a file version, contents of a file is organized in a byte stream then a one-way hashing function is applied to the byte stream. Generally, the same one-way hashing function is used for calculating both application and file versions.

An application or data typically comprises a set of files. When an application or data is updated, one or more of a corresponding set of files is updated (i.e., added, modified, or removed). In an exemplary embodiment, one or more difference files are created by the gateway 108 or the 3i server 104 that represents the difference between the old version and the new version of the application to be updated. A difference file provides information regarding a file to be added to an original set of files, a file in an original set of files that should be modified, or a file in an original set of files that should be deleted. For example, to add a file, a difference file includes the file's name, a 16-byte version information, contents of the new file, and the size of the new file in bytes. To delete a file, a difference file includes the name of the file to be deleted. To modify a file, a difference file includes a description of the difference between the modified file and the original file or the contents of the modified file, whichever is smaller.

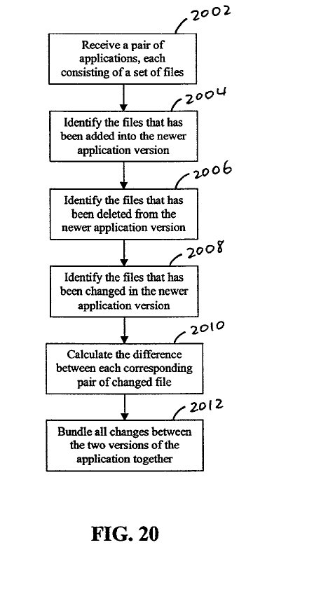

FIG. 20 illustrates an exemplary process to identify the difference between an old application and a new application in accordance with an embodiment of the invention. At step 2002, an old application and a new application are received. Each application comprises a set of files. Next, the files that were added into the new application are identified (step 2004). The files that were deleted from the new application are identified (step 2006). The files that were modified in the new application are identified (step 2008). The difference between each corresponding pair of changed files is calculated (step 2010). All calculated changes are bundled together (step 2012).

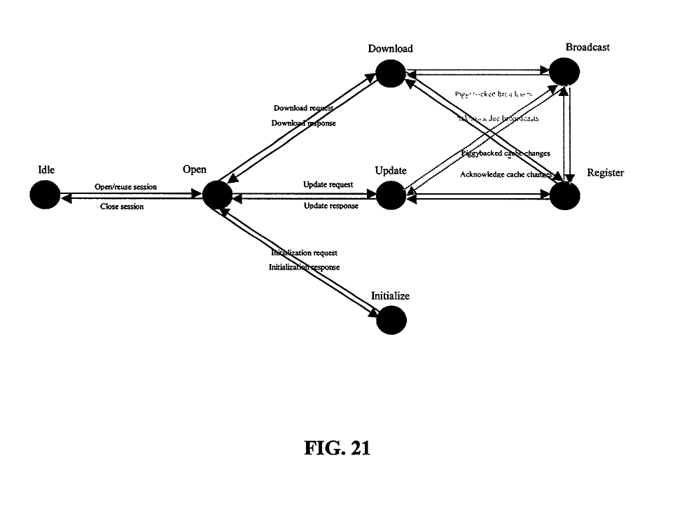

The smart connectivity protocol (SCP) is a protocol used for application/data management between the mobile device 110 and the gateway 108 or between the mobile device 110 and a remote server 102. FIG. 21 illustrates exemplary state machines of the SCP in accordance with an embodiment of the invention. Generally, when the SCP is in an Idle state, no communication session is created and, thus, no communication activity is taking place. When the SCP is in an Open state, a communication session is created; the system may be for communication requests from a client. When the SCP is in a Download state, a download request is sent or a download response is prepared. When the SCP is in an Update state, an update request is sent or an update response is prepared. When the SCP is in an Initialize state, an initialization request is sent or an initialization is prepared. When the SCP is in a Register state, cache changes are piggybacked or an acknowledgment is prepared. When the SCP is in a Broadcast state, broadcasts are piggybacked or an acknowledgment is prepared.

The foregoing examples illustrate certain exemplary embodiments of the invention from which other embodiments, variations, and modifications will be apparent to those skilled in the art. The invention should therefore not be limited to the particular embodiments discussed above, but rather is defined by the claims.

What is claimed is:

1. A method for managing caches on a gateway, comprising the steps of:
periodically checking a set of records in a database, each of said set of records corresponding to a set of files;
selecting a record based on said checking;
contacting a server to update or check status of a set of files corresponding to said record; and
updating said set of files and said record in accordance with a response from said server.

2. The method of claim 1, wherein said periodically checking includes the steps of:
checking a first field of each record in said database to determine if a set of files corresponding to said record is up-to-date;
checking a second field of each record in said database to determine if a next version release schedule corresponding to said record has expired; and
checking a third field of each record to determine if an estimated update interval corresponding to said record has occurred.

3. The method of claim 1, wherein each of said set of records is sequentially checked during said periodically checking step.

4. The method of claim 1, wherein said selecting includes the step of:
selecting a record having a corresponding sets of files that needs a status check or an update.

5. The method of claim 1, wherein said contacting a server includes the steps of:
authenticating said set of files;
establishing a communication session with said server;
sending an update request or a status check request to said server; and
receiving an update response or a status check response from said server, said update response including at least one difference file and said status check response including a current version and status of said set of files.

6. The method of claim 5, wherein said updating said set of files includes the steps of:
applying said at least one difference file to said set of files; and
updating at least one table in said database.

7. The method of claim 5, wherein said updating said set of files includes the step of:
updating at least one table in said database based on said current version and status of said set of files.

8. The method of claim 5, further comprising the steps of:
parsing said update response or said status check response for a broadcast message;
accessing and updating at least one table in said database based on said broadcast message; and
sending a broadcast response to said server.

9. The method of claim 1, wherein said contacting a server includes the steps of:
authenticating said set of files;
establishing a connection with said server;
downloading a current set of files from said server;
comparing said current set of files to said set of files; and
generating at least one difference file or a current version and status based on said comparing.

10. The method of claim 9, wherein said updating said set of files includes the steps of:
applying said at least one difference file to said set of files; and
updating at least one table in said database.

11. The method of claim 9, wherein said updating said set of files includes the steps of:
replacing said set of files by said current set of files;
storing said at least one difference file; and
updating at least one table in said database.

12. The method of claim 9, wherein said updating said set of files includes the step of:
updating at least one table in said database based on said current version and status.

13. A computer program product for use in conjunction with a computer system for managing caches on a gateway, comprising:
logic code for periodically checking a set of records in a database, each of said set of records corresponding to a set of files;
logic code for selecting a record based on said checking;
logic code for contacting a server to update or check status of a set of files corresponding to said record; and
logic code for updating said set of files and said record in accordance with a response from said server.

14. The computer program product of claim 13, wherein said logic code for periodically checking includes:
logic code for checking a first field of each record in said database to determine if a set of files corresponding to said record is up-to-date;
logic code for checking a second field of each record in said database to determine if a next version release schedule corresponding to said record has expired; and
logic code for checking a third field of each record to determine if an estimated update interval corresponding to said record has occurred.

15. The computer program product of claim 13, wherein said logic code for periodically checking includes logic code for sequentially checking each of said set of records.

16. The computer program product of claim 13, wherein said logic code for selecting includes:
logic code for selecting a record having a corresponding sets of files that needs a status check or an update.

17. The computer program product of claim 13, wherein said logic code for contacting a server includes:
logic code for authenticating said set of files;
logic code for establishing a communication session with said server;
logic code for sending an update request or a status check request to said server; and
logic code for receiving an update response or a status check response from said server, said update response including at least one difference file and said status check response including a current version and status of said set of files.

18. The computer program product of claim 17, wherein said logic code for updating said set of files includes:
logic code for applying said at least one difference file to said set of files; and
logic code for updating at least one table in said database.

19. The computer program product of claim 17, wherein said logic code for updating said set of files includes:
logic code for updating at least one table in said database based on said current version and status of said set of files.

20. The computer program product of claim 17, further comprising:
logic code for parsing said update response or said status check response for a broadcast message;
logic code for accessing and updating at least one table in said database based on said broadcast message; and
logic code for sending a broadcast response to said server.

21. The computer program product of claim 13, wherein said logic code for contacting a server includes:
logic code for authenticating said set of files;
logic code for establishing a connection with said server;
logic code for downloading a current set of files from said server;
logic code for comparing said current set of files to said set of files; and
logic code for generating at least one difference file or a current version and status based on said comparing.

22. The computer program product of claim 21, wherein said logic code for updating said set of files includes:
logic code for applying said at least one difference file to said set of files; and
logic code for updating at least one table in said database.

23. The computer program product of claim 21, wherein said logic code for updating said set of files includes:
logic code for replacing said set of files by said current set of files;
logic code for storing said at least one difference file; and
logic code for updating at least one table in said database.

24. The computer program product of claim 21, wherein said logic code for updating said set of files includes:
logic code for updating at least one table in said database based on said current version and status.
